(19) United States
(12) Patent Application Publication
(10) Pub. No.: US 2011/0004982 A1
(43) Pub. Date: Jan. 13, 2011

(54) COVERALL WITH DROP SEAT

(75) Inventors: Jan Henningsen, Saltum (DK); Jadwiga Luksza, Stargard Szcz (PL)

Correspondence Address: MERCHANT & GOULD PC, P.O. BOX 2903, MINNEAPOLIS, MN, 55402-0903, US

(73) Assignee: Red Wing Shoe Company, Inc., Red Wing, MN (US)

(21) Appl. No.: 12/724,808

(22) Filed: Mar. 16, 2010

Related U.S. Application Data
(60) Provisional application No. 61/162,123, filed on Mar. 20, 2009.

(51) Int. Cl. A62B 17/00; A41D 13/02; A41D 27/00

(52) U.S. Cl. 2/458; 2/79; 2/243.1

(57) ABSTRACT

The present disclosure provides an improved one-piece garment having a drop seat. The garment includes a jacket portion and a pants portion and fastener devices that selectively connect the pants portion to the jacket portion. The fastener devices are configured and arranged to be relatively easily manipulated by the user of the garment. The garment is configured so that the user can use the toilet without getting out of the garment. In some embodiments the garment is a fire protection coverall. A method of lowering the pants portion from the jacket portion of a one-piece garment is also provided.

### CROSS-REFERENCE TO RELATED APPLICATIONS

This application claims priority to provisional application number 61/162,123 filed on Mar. 20, 2009 titled Coverall with Drop Seat, the entire disclosure of which is hereby incorporated by reference.

### TECHNICAL FIELD

The present disclosure provides a one-piece garment having a rear release mechanism that allows for the use of a toilet without taking off the upper portion of the garment.

### BACKGROUND

One-piece garments, commonly referred to as coveralls or jumpsuits, are often worn by laborers. Some employers require that such garments be worn, as they can in some cases provide certain advantages in the work place (e.g., safety and efficiency advantages). Typically, these garments include a vertical front enclosure that is used to get into and out of the garment. If the wearer of the garment wishes to use the toilet, he or she typically need to first get completely or substantially out of the garment, which can be inconvenient.

To address this issue with one-piece garments, various drop seat configurations have been developed. For, example, see U.S. Pat. No. 3,949,427 to Sampey titled Garment with Drop Seat; U.S. Pat. No. 3,994,026 to Sampey titled Garment with Supported Drop Seat; U.S. Pat. No. 4,607,396 to Craig titled Coverall Garment with Concealed Seat Panel; U.S. Pat. No. 5,014,356 to Tomasi-Dubois titled Dropseat Jumpsuit; U.S. Pat. No. 5,896,581 to Wong titled Unitary Clothing With An Improved Drop-Seat; U.S. Pat. No. 6,477,711 to Freeman et al. titled Unitary Garment; and U.S. Pat. No. 6,944,883 to Cuaz titled Jumpsuit For a Woman and Method of Use. Despite the existence of these various drop seat configurations, there remains a need for an improved configuration.

### SUMMARY

The present disclosure provides an improved one-piece garment having a drop seat. The garment includes a jacket portion and a pants portion and fastener devices that selectively connect the pants portion to the jacket portion. The fastener devices are configured and arranged to be relatively easily manipulated by the user of the garment. The garment is configured so that the user can use the toilet without getting out of the garment. In some embodiments the garment is a fire protection coverall. A method of lowering the pants portion from the jacket portion of a one-piece garment is also provided.

### BRIEF DESCRIPTION OF THE DRAWINGS

FIG. 1 is a front view of a garment according to the principles of the present disclosure; and

FIG. 2 is a rear view of a garment according to the principles of the present disclosure.

### DETAILED DESCRIPTION

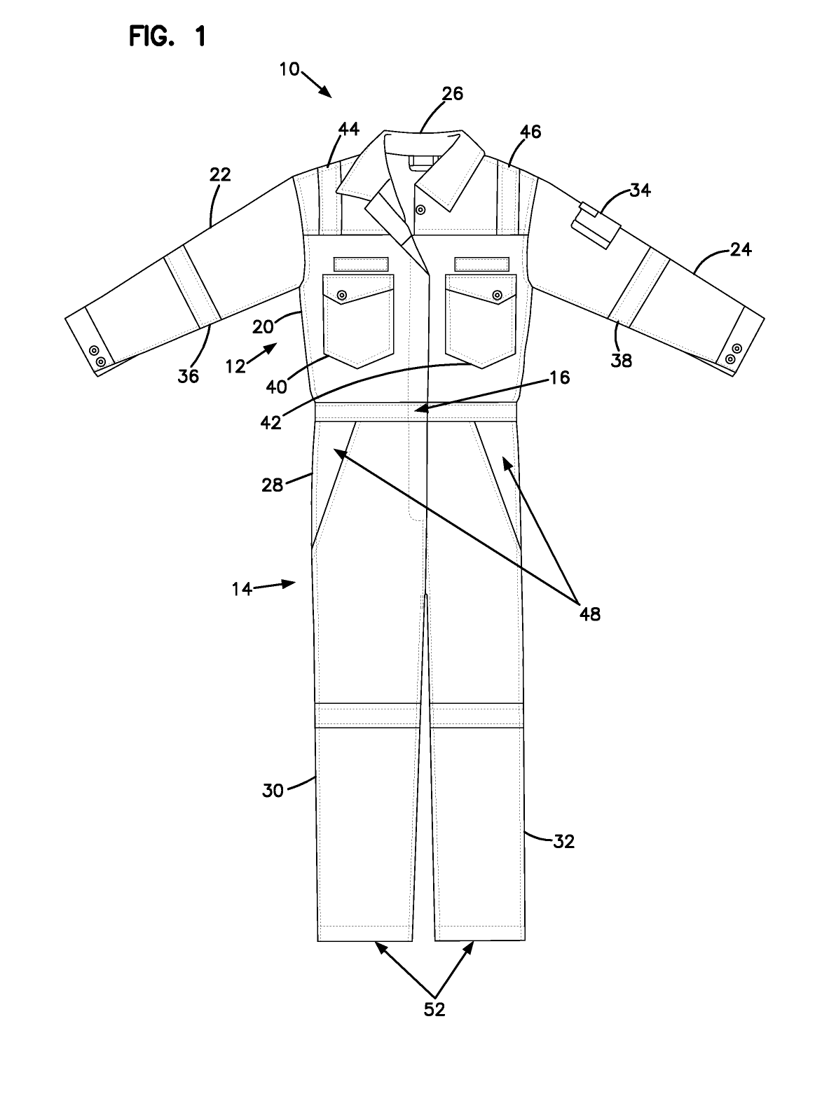

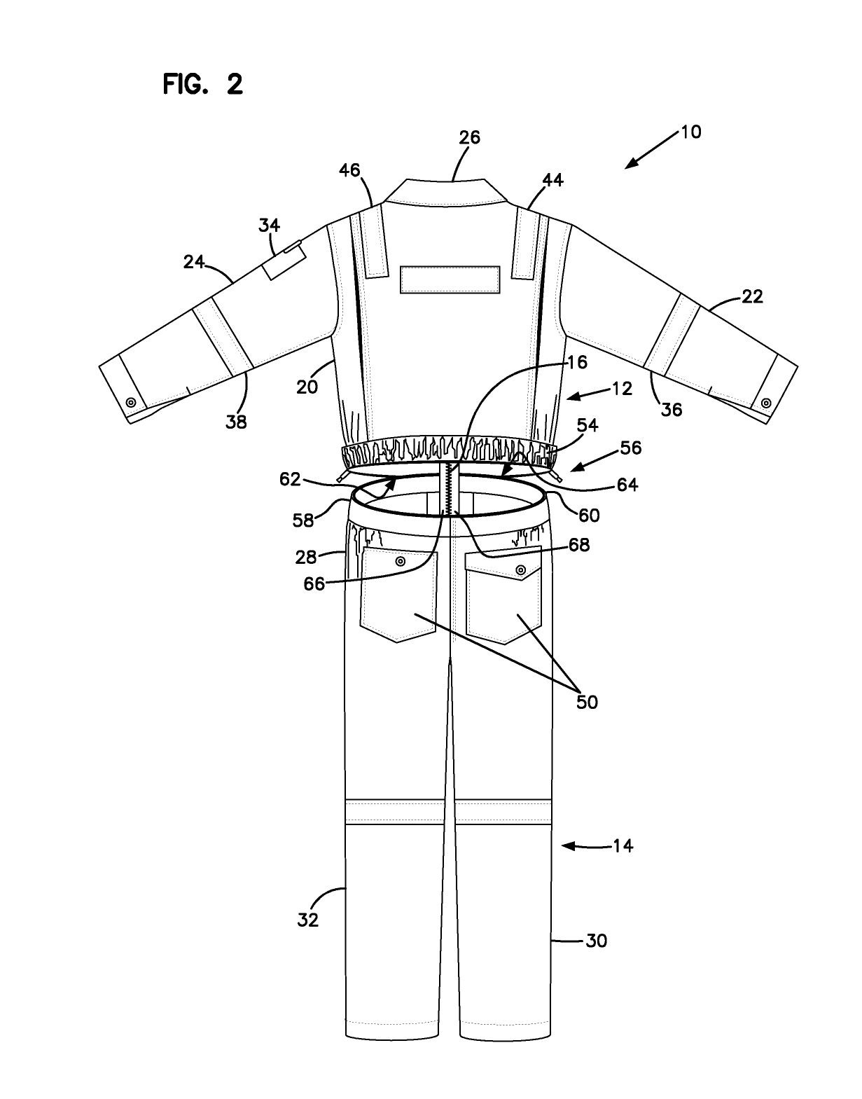

Referring to FIGS. 1 and 2, an embodiment of the garment according to the present disclosure is shown. In the depicted embodiment the garment 10 includes an upper jacket portion 12 and a lower pants portion 14. The upper jacket portion 12 is connected to the lower pants portion 14 via closure system 56 that allows the user to partially detach the lower pants portion 14 from the upper jacket portion 12 when desired. One advantage of the garment 10 is that the wearer of the garment 10 can easily use the restroom while still wearing the upper jacket portion 12 of the garment.

In the depicted embodiment the upper jacket portion 12 of the garment includes a torso portion 20 for receiving a person's torso, arm portions 22, 24 for receiving a person's arms, and a collar 26 for a person's head to extend through. In the depicted embodiment, the arm 24 is shown having a small pocket 34 attached thereto for storing thing such as a mobile phone and/or writing device. Also, both arm portions 22, 24 are shown to include reflective bands 36, 38 for added visibility in low light work situation. In the depicted embodiment the torso portion 20 includes two chest pockets 40, 42, two reflective shoulder patches 44, 46, and an elastic waistband 54. It should be appreciated that many other alternative embodiments of the upper jacket portion 12 are possible. Alternative upper jacket portions may include different features than those shown in the above-described depicted embodiment.

In the depicted embodiment the lower pants portion 14 includes a crotch portion 28 and leg portions 30, 32 for receiving a person's legs. The crotch portion 28 includes two side pockets 48 and two rear pockets 50. The leg portions 30, 32 include adjustable ankle closures 52 so that the garment 10 can be put on or taken off over the person's footwear. The adjustable ankle closures 52 include snaps that can make the ankle opening smaller once the person has extended his or her foot through the leg portions 30, 32 of the garment 10. In the depicted embodiment the leg portions 30, 32 also include reflective bands attached thereto for added visibility. It should be appreciated that many other alternative embodiments of the lower pants portion 14 are possible. Alternative pants portions may include different features than those shown in the above-described depicted embodiment.

In the depicted embodiment the garment 10 includes a vertical enclosure 16 that extends from the upper jacket portion 12 into the lower pants portion 14. The vertical enclosure 16 can be opened to allow the user of the garment to get into or get out of the garment. The vertical enclosure in the depicted embodiment is a zipper that is concealed by a vertical flap that can be snapped over the zipper once the zipper is closed. In the depicted embodiment the zipper is configured to open downwardly in that it opens by pulling the zipper from its upper end adjacent the collar 26 to its lower end located in the crotch portion 28 of the garment 10. It should be appreciated that many other alternative embodiments of the enclosure 16 are possible. Alternative enclosures 16 may, for example, not include a zipper that is vertically arranged in the front center of the garment as shown.

In the depicted embodiment the closure system 56 includes a first closure device 58 and a second closure device 60 that cooperatively substantially connect the upper jacket portion 12 to the lower pants portion 14. In the depicted embodiment the closure devices are typically copper or nylon zippers that open as they are pulled from their ends located at the back of the jacket to their ends located adjacent the vertical enclosure 16. In the depicted embodiment the ends 62, 64 located adjacent the vertical enclosure are spaced on either side of the vertical enclosure 16. The space between the ends 62, 64 is preferably between ½ of an inch to 10 inches, and more preferably between 2 inches to 6 inches. In the depicted embodiment the space between the ends of the zippers adjacent the vertical enclosure is about 4 inches.

In the depicted embodiment the closure system 56 is configured so that even when the first and second closure devices 58, 60 are completely open, the upper jacket portion 12 and the lower pants portion 14 remain connected. This feature prevents the garment becoming separated during use intentionally by the wearer of the garment or inadvertently during laundering of the garment.

In the depicted embodiment the garment 10 is fire protectant and is constructed of an aromatic polyamide material commonly referred to under the trade name Nomex®. The term fire protectant construction as used herein refers generally to any construction that inhibits or resists fire and includes, among other things, fire resistant textiles, antiflame textiles, fireproof material, non-fire resistant textiles treated with fire resistant coating, inherently fire retardant materials, permanently fire retardant materials, durably fire retardant materials, flash resistant materials, flame resistant materials, etc. Given that the garment 10 of the depicted embodiment is configured for fire protection, it is desirable that the garment 10 include features that prevent the user from only wearing portions of the garment 10. In the depicted embodiment the first and second closure devices 58, 60 are concealed via a skirt of fire retardant material. It should be appreciated that in alternative embodiments the garment 10 may be constructed of materials that are not fire retardant.

In use the lower pants portion 14 of the garment 10 can be partially separated from the upper jacket portion 12 by reaching around one's back and unzipping a first zipper (first closure device 58) with one's left hand by pulling the opening end 66 of the zipper towards one's navel and reaching around one's back and unzipping a second zipper (second closure device 60) with one's right hand by pulling the opening end 68 of the zipper towards one's navel. This step can be accomplished in sequence or simultaneously. Once accomplished, the rear portion of the lower pants portion 14 is free to drop downward. In the depicted embodiment the lower pants portion 14 can be dropped with or without opening the vertical enclosure 16. The lower pants portion 14 can be easily reconnected to the jacket by pulling the first and second zippers from one's navel to the center of one's back.

It should be appreciated that many other alternative embodiments of the closure system 56 are possible. Alternative pants portions may include different features than those shown in the above-described depicted embodiment. For example, in alternative embodiments the closure device can be devices other than zippers, and if they are zipper they can include construction other than copper or nylon. Also, the closure devices can be opened in directions other than from the center of the back of the jacket portion to the front of the jacket portion.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A one-piece fire protection garment comprising:
a body portion including a fire protectant construction, the body portion including an upper jacket portion and a lower pants portion;
a first zipper including a first end and a second end, the first zipper extending generally vertically from the upper jacket portion into the lower pants portion;
a second zipper including a first end and a second end; and
a third zipper including a first end and a second end;
wherein the second and third zippers are arranged to connect a portion of the upper jacket portion to a portion of the lower pants portion;
wherein the first end of the second zipper extends from a first location located on the first side of the first zipper;
wherein the first end of the third zipper extends from a second location located on the second side of the first zipper;
wherein the first and second locations are between ½ to 10 inches of each other.

2. The garment of claim 1, wherein the first and second locations are between 2 to 6inches of each other.

3. The garment of claim 1, wherein the second ends of the second and third zippers are aligned when the zippers are in a fully closed position.

4. The garment of claim 1, wherein the second zipper is configured to open from its second end to its first end, and wherein the third zipper is configured to open from its second end to its first end.

5. The garment of claim 1, wherein the fire protectant construction of the body portion has an aromatic polyamide construction.

6. The garment of claim 1, wherein the jacket includes an elastic waistband adjacent to the second and third zippers.

7. The garment of claim 1, wherein the first, second, and third zippers are concealed.

8. The garment of claim 1, wherein the upper jacket portion includes arms and is constructed of a fire retardant material.

9. The garment of claim 8, wherein the lower pants portion is constructed of a fire retardant material.

10. A one-piece garment comprising:
an upper jacket portion;
a lower pants portion;
a first fastener device extending vertically from the upper jacket portion into the lower pants portion;
a second fastener device including a first end and a second end; and
a third fastener device including a first end and a second end;
wherein the second and third fasteners are arranged to connect a portion of the upper jacket portion to a portion of the lower pants portion;
wherein the first end of the second fastener device extends from a first location located on the first side of the first fastener device;
wherein the first end of the third fastener device extends from a second location located on the second side of the first fastener device;
wherein the first and second locations are between ½ to 10 inches of each other.

11. The garment of claim 10, wherein the first and second locations are between 2 to 6 inches of each other.

12. The garment of claim 10, wherein the second end of the second and third fasteners are aligned when the fasteners are in a fully closed position.

13. The garment of claim 10, wherein the jacket includes an elastic waistband adjacent to the second and third fasteners.

14. The garment of claim 10, wherein the first, second, and third fasteners are concealed.

15. A method of lowering a pants portion from a jacket portion of a one-piece garment comprising:
reaching around one's back and unzipping a first zipper with one's left hand by pulling a zipper mechanism towards one's navel;
reaching around one's back and unzipping a second zipper with one's right hand by pulling a zipper mechanism towards one's navel;
allowing the pants portion to drop downward from the jacket portion.

16. The method of claim 15, wherein the first and second zippers are configured such that unzipping the first and second zippers does not completely detach the pants portion from the jacket portion.

17. The method of claim 15, wherein the pants portion is configured to drop away downwards from the jacket potion without unzipping any other fasteners on the garment.

18. The method of claim 15, wherein reconnecting the rear portion of the pants portion to the rear portion of the jacket portion includes pulling the zipper mechanism of the first and second zippers from one's navel to the center of one's back.

19. The method of claim 15, wherein the first and second zippers are configured to be covered automatically when the first and second zippers are in the fully closed position.
